(19) United States
(12) Patent Application Publication
(10) Pub. No.: US 2015/0022159 A1
(43) Pub. Date: Jan. 22, 2015

(54) DETECTION OF A MALFUNCTION IN AN ELECTROCHEMICAL ACCUMULATOR

(71) Applicant: Commissariat à L'énergie Atomique et aux énergies alternatives, Paris (FR)

(72) Inventors: Pierre Perichon, Voiron (FR); François Alcouffe, Grenoble (FR); Roland Blanpain, Entre-Deux-Guiers (FR); Johann Lejosne, Lentigny (FR)

(21) Appl. No.: 14/371,356

(22) PCT Filed: Jan. 8, 2013
(86) PCT No.: PCT/EP2013/050188

§ 371 Date: Jul. 9, 2014

(30) Foreign Application Priority Data
Jan. 9, 2012 (FR) 1250191

(51) Int. Cl. H02J 7/00; H01M 4/58; H01M 10/48; H01M 10/0525; H01M 10/42

(52) U.S. Cl. CPC H02J 7/0029; H01M 10/0525; H01M 10/425; H01M 10/486; H01M 4/5825; H01M 2010/4271; H02J 7/007
USPC 320/136; 429/90

(57) ABSTRACT

An electrochemical accumulator, including a casing, at least two electrodes and an electrolyte contained in the casing. There is a ferromagnetic material contained in the casing and having remanent magnetization. There is also a magnetic sensor arranged outside the casing and capable of measuring a remanent magnetic field of said ferromagnetic material. There is further included a circuit configured to determine the temperature inside the casing as a function of the measured remanent magnetic field.

### RELATED APPLICATIONS

This application is a U.S. National Stage of international application No. PCT/EP2013/050188 filed Jan. 8, 2013, which claims the benefit of the priority date of French Patent Application FR 1250191, filed on Jan. 9, 2012, the contents of which are herein incorporated by reference.

### FIELD OF INVENTION

The invention relates to accumulator batteries including a large number of electrochemical accumulators.

### BACKGROUND

Certain accumulators take the form of spiral generators of cylindrical shape. Such an accumulator includes an electrochemical bundle included in a spiral roll. The roll is formed from the winding of a positive electrode and a negative electrode alternating with first and second layers forming separators. The separators serve to electrically insulate the positive electrode from the negative electrode. The separators also serve to insulate the outer parts, positive and negative respectively, of the accumulator.

The roll is generally housed in a cylindrical sealed metal case. One side of the metal case forms the negative pole. The roll is bathed in an electrolyte that allows an ion exchange. A lid is connected, generally by welding, to the positive electrode by way of a connection and forms the positive pole. The lid is electrically insulated from the case.

Due to the increasingly widespread use of such accumulators, their manufacturing process has become increasingly well-controlled. Such accumulators thus have a high degree of reliability. The use of such accumulators is therefore favored for batteries requiring a high level of safety and a large number of accumulators. Such batteries are in particular produced on a large scale to power portable computers.

Although rare, one possible malfunction of such an accumulator is the appearance of a short-circuit by the piercing of a separator. According to various studies, such a short-circuit is triggered by a localized piercing of a separator. The main causes at the origin of such a piercing are wear of the separator, the creation of metal dendrites in certain operating conditions, or the presence of undesirable debris in the accumulator following a poorly-controlled manufacturing process.

The batteries, in particular using lithium ion technology, possess a specific energy that is constantly increased. Technologically, such accumulators have a limited voltage across their terminals, in the order of 2 to 4 V in most cases. In high-voltage and high-power applications, the batteries must include a very large number of accumulators connected in series. To facilitate the handling and dimensioning of the batteries, the capacity of a battery is adapted by connecting an adequate number of accumulators in parallel. Consequently, such batteries have a much higher risk of a short-circuit appearing, with consequences that are all the more important when the specific energy is high and the malfunction can propagate to a large number of accumulators. Thus, the short-circuited accumulator can be faced with thermal runaway with melting of these various components. This thermal runaway can spread to adjacent accumulators and to the system that powers it.

Technical developments made with such accumulators have essentially concerned the reinforcement of the separators and the composition of the electrodes in order to limit the probability of a piercing and/or to increase the resistance in a possible short-circuit. The proposed solutions induce a substantial rise in the cost price of the accumulator, a substantial increase in its volume and/or a limited improvement of the safety of the accumulator, which can be incompatible with mass-market or transport applications.

It is known practice to fasten a temperature probe to an accumulator to identify and prevent certain types of malfunction. Depending on the resistance of the accidental short-circuit, a more or less rapid heating of the accumulator will be obtained. For a slow heating generated by the short-circuit, such a heating is difficult to distinguish from the temperature variations of the environment or temperature variations due to the operating currents flowing through the accumulator. For a fast heating, fast and considerable heating initially occurs in a localized way. On the external wall of the accumulator the heating occurs much later and initially in a localized way. Overall heating of the accumulator only occurs later. Thus, when the external temperature probe makes it possible to determine the appearance of a short-circuit with certainty, it is often too late to avoid the destruction of the accumulator. Due to the flammability of certain accumulator materials, the destruction of the accumulator can accompany the start of a fire.

The inclusion of temperature probes inside an accumulator would turn out to be at once ineffective for most malfunctions, and would on the contrary risk structurally forming an additional source of short-circuit risk. Consequently, faced with the difficulty_of detecting a rise in the temperature in an accumulator in time, designers have been forced to choose accumulator chemistries that are safer but less optimal in performance terms. This choice is all the more crucial for power applications and applications in the presence of users.

### SUMMARY

The invention aims to solve one or more of these drawbacks. The invention thus relates to an electrochemical accumulator and to a power supply system as defined in the appended claims. Other features and advantages of the invention will become more clearly apparent from the following description of them hereinafter, for information purposes and in no way limiting, with reference to the appended drawings.

### BRIEF DESCRIPTION OF THE DRAWINGS

FIG. 1 is a section view of an example of an accumulator for which the invention can be implemented;

FIG. 2 is a magnified schematic section view of a local short-circuit at a separator;

FIG. 3 is a schematic representation of an accumulator equipped with a first variant of a device for measuring temperature for an early detection of a short-circuit;

FIG. 4 is a diagram illustrating the temperatures, measured by probes inside and outside an accumulator respectively, of an accumulator at the short-circuit during validation tests of the measurement device;

FIG. 5 illustrates the inverse of the magnetic susceptibility of the LiFePO₄ as a function of temperature;

FIG. 6 illustrates a difference in magnetic field measured by the measurement device during a validation test;

FIG. 7 illustrates the temperature measured by the probe outside the accumulator during the validation test;

FIG. 8 is a schematic representation of a battery including accumulators according to the invention;

FIG. 9 is an example of a hysteresis loop of a ferromagnetic material;

FIG. 10 illustrates the saturation magnetic field of an example of a ferromagnetic material as a function of its temperature;

FIG. 11 illustrates the saturation polarization and the anisotropic field of a hexagonal barium ferrite;

FIG. 12 is a schematic representation of an accumulator equipped with a second variant of a temperature measurement device for an early detection of a short-circuit.

### DETAILED DESCRIPTION

The invention proposes to measure the temperature inside the casing of an electrochemical accumulator including ferromagnetic material by performing a measurement of the remanent magnetic field of the ferromagnetic material from the outside of the casing.

The invention makes it possible to perform a temperature measurement without compromising the seal of the casing and more rapidly, which makes it possible to reduce the consequences of a possible short-circuit in the accumulator.

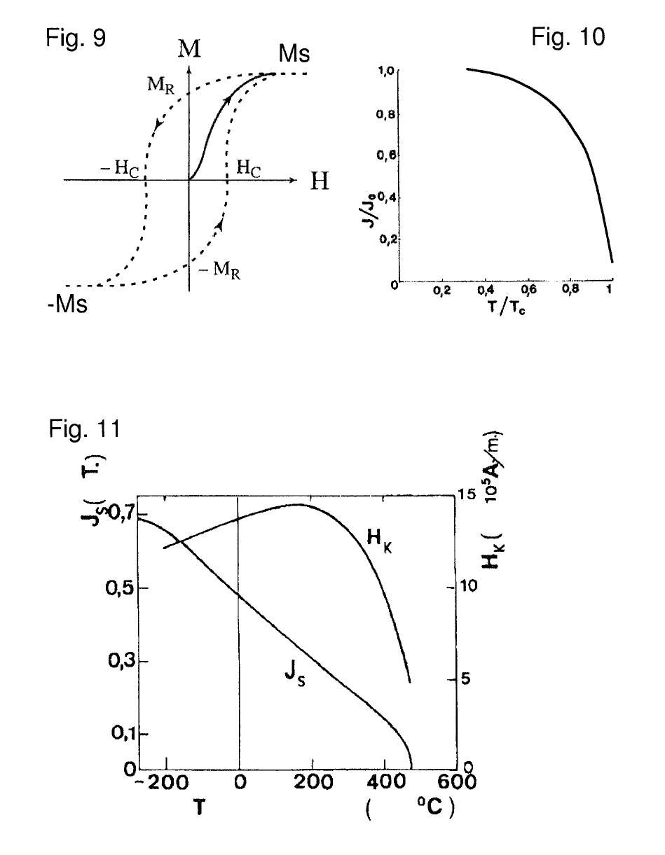

Ferromagnetic materials have a substantially invariant magnetic susceptibility and a generally non-linear magnetization in response to the application of a magnetic field. The magnetization characteristic of a ferromagnetic material is thus usually defined by a diagram as illustrated in FIG. 9. The first magnetization curve is illustrated by a solid line, and the hysteresis loop of such a material is illustrated by a dotted line.

Under the action of a growing magnetic field, the magnetization increases to saturation at a value Ms. By suppressing the magnetic field H, a residual or remanent magnetization Mr is then preserved. By applying a negative magnetic field of growing amplitude, the magnetization ends up reaching a saturation value −Ms. By suppressing the magnetic field H, the remanent magnetization, Mr, is then preserved.

FIG. 10 illustrates the value Ms for an example of a ferromagnetic material such as Cobalt, as a function of a T/Tc ratio. T corresponds to the temperature of the material, Tc corresponds to its Curie temperature, from which any remanent magnetization disappears. The value of the remanent magnetization Mr being proportional to the value Ms, it is also a function of the temperature of the material. The invention proposes to draw benefit from the influence of the temperature on the remanent magnetization to determine a temperature inside an accumulator casing on the basis of a measurement of the remanent magnetic field from the outside of the casing.

Usually, systems based on a measurement of magnetization of a ferromagnetic material are based on the measurement of the magnetic susceptibility of the material and thus suppose the choice of a material having as low a remanent field as possible. The invention on the contrary involves the use of a material for which the remanent magnetic field is as high as possible.

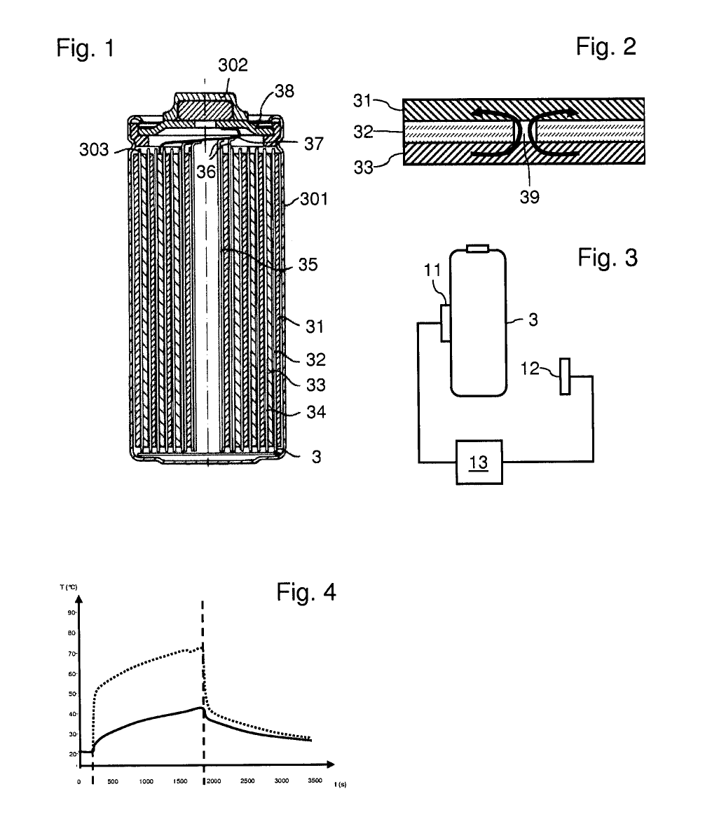

FIG. 1 is a section view of an electrochemical accumulator 3. This accumulator 3 is in this case a spiral accumulator of cylindrical shape. Such an accumulator 3 includes a spiral roll. The accumulator 3 comprises a cylindrical case or casing 301 in which the spiral roll of the electrodes is housed. The cylindrical case or casing 301 is typically conducting. The cylindrical case 301 can be made of metal and be sealed. The spiral roll includes a flexible rectangular plate of negative electrode 31, a flexible rectangular plate of positive electrode 33 and two separators 32 and 34. The separators 32 and 34 can be formed from one and the same layer folded at one end. The electrodes 31 and 33 and the separators 32 and 34 are wound around the axis of the cylindrical case 301. In this case the electrodes 31 and 33 and the separators 32 and 34 are wound around an insulating shaft 35. This insulating shaft 35 is fixed in the central part of the accumulator 3. The winding is produced in such a way as to produce an alternation of positive electrode-separator-negative electrode-separator layers. Each separator 32, 34 serves to electrically insulate the positive electrode 33 from the negative electrode 31. The separators 32 and 34 can also serve to mutually insulate the outer parts, negative and positive respectively, of the accumulator 3. The roll is bathed in an electrolyte which allows an ion exchange.

An inner face of the case 301 forms the negative pole. A positive pole 302 is connected, generally by welding, to the positive electrode 33 by way of a connection 37 and a lid 38. The positive pole 302 and the lid 38 are electrically insulated from the case 301.

Part 303 of the separators 32 and 34 is in axial projection to avoid contact between the electrodes 31 and 33. In proximity to the axis of the accumulator 3, spacers 36 project axially with respect to the electrodes 31, 33 and the separators 32, 34. The spacers 36 bear the connection 37. The spacers 36 can be formed by projections of the central turns of the separators 32 and 34. Thus, the spacers 36 prevent the connection 37 from accidentally coming into contact with the negative electrode 31.

FIG. 2 is a magnified section view of a superposition of layers of the roll in an example of a local short-circuit. In the example, the separator 32 interposed between the negative electrode 31 and the positive electrode 33 includes a through-hole 39. An electric current is established between the electrode 33 and the electrode 31 through the hole 39, as illustrated by the arrows. Given the quantity of energy that can be stored in the electrodes 31 and 33, the current flowing through the hole 39 can have a very high amplitude and lead to heating of the electrodes 31, 33 and of the film 32. The heating can induce a chain deterioration inside the accumulator 3. A destruction of the accumulator 3 can induce enough heating to spread to other adjacent accumulators of the rest of a battery or to the system to be powered.

FIG. 4 is a diagram representing a simulation of malfunctions of an accumulator 3. In this diagram, the dotted curve illustrates the temperature inside the accumulator 3 at the level of a short-circuit and the solid curve illustrates the temperature measured by a sensor of thermocouple type arranged in a conventional way outside the casing 301. The simulated loop comprises a first phase of heating, followed by a second phase of cooling. The measurements were taken by including a controlled heating resistor inside the casing 301.

It is observed that the temperature measured outside by the thermocouple only rises slowly and with a certain delay. Moreover, this temperature measured outside the casing 301 keeps a relatively limited amplitude, that it is difficult to tell apart from normal heating in the process of discharging the accumulator 3. It is necessary to wait for a lengthy period of time in order to be able to determine that the outer temperature has reached an abnormal amplitude related to a short-circuit.

FIG. 3 is a schematic representation of an accumulator 3 according to an exemplary embodiment of the invention. The accumulator 3 can have the structure illustrated in FIG. 1 and thus comprise a casing including two electrodes of opposite polarities immersed in an electrolyte. The positive electrode and the negative electrode can thus each include respective conducting films. The conducting films of these electrodes can be superposed in alternation and separated by at least one insulating separator film. As in the example in FIG. 1, the electrode films and the separator films can be superposed in alternation in a winding around an axis, so as to form an accumulator 3 in the shape of a roll.

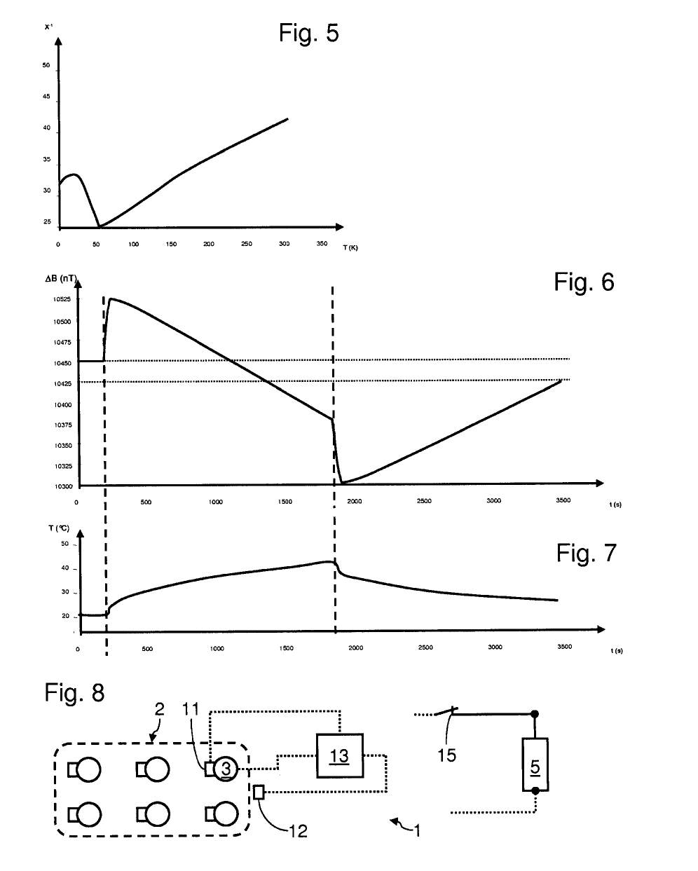

Some ferromagnetic material is contained in the casing. The ferromagnetic material is for example included in one or both of the electrodes, in order to increase the amplitude of the remanent magnetic field generated. An accumulator 3 of lithium-ion type itself contains some LiFePO₄ which is an antiferromagnetic material, the susceptibility of which is low with respect to that of certain ferromagnetic materials. FIG. 5 illustrates the inverse of the magnetic susceptibility of the LiFePO₄ along the ordinate as a function of its temperature along the abscissa. Generally, the ferromagnetic material already present in a lithium-ion battery is sensitive to temperature, which modifies its magnetization until it is made very weak as the Curie temperature is approached.

If the material of the electrodes at the basis of the electrochemical reaction is only too weakly ferromagnetic, additional ferromagnetic material can be included in the accumulator. Such an additional material will advantageously have a Curie temperature below 600° C., preferably below 400° C. With such a Curie temperature, one will have a good sensitivity of measurement to the rise in temperature. For example, at least one of the two electrodes can include an additional ferromagnetic material. This material will be advantageously chosen for the high amplitude of its remanent magnetic field or of its coercive field Hc. One of the two electrodes can thus include barium ferrite or strontium ferrite.

The accumulator 3 comprises a magnetic sensor 11 placed outside the casing of the accumulator 3. This avoids the installation of the magnetic sensor 11 damaging the seal of the accumulator 3 and does not increase the risk of appearance of a short-circuit in the casing. The magnetic sensor 11 is capable of measuring the variations in magnetic field inside the casing of the accumulator 3. The sensor 11 is advantageously fastened to the casing of the accumulator 3 to present maximum sensitivity to the variations in magnetic fields inside the casing of the accumulator 3. In the absence of magnetizing magnetic field being applied from the outside, the sensor 11 thus measures the sum of the ambient magnetic field and the remanent magnetic field of the inside of the casing.

In a cylindrical accumulator 3, the sensor 11 is advantageously configured to essentially measure the magnetic field perpendicular to the axis of the accumulator and to reject the magnetic field along the axis of this accumulator 3. Thus, the sensor 11 is less sensitive to the currents from the charging and discharging of the accumulator 3 in normal operation, at the origin of a magnetic field along the axis of the accumulator 3. The variation in the remanent magnetic field generated by the heating of the ferromagnetic material will generally be observable along one direction. Such a variation in the field will indeed be measured by a sensor 11 capable of measuring the radial component of the magnetic field inside the casing from the moment that it is able to align with the direction of said field. In this example, a considerable magnetization of the accumulator 3 is produced before it is put to use, in order to obtain a meaningful level of the remanent magnetic field of the ferromagnetic material. This prior magnetization can define a non-isotropic remanent magnetic field of the ferromagnetic material, with a dominant orientation. The sensor 11 is advantageously positioned to measure the remanent magnetic field in this dominant orientation.

The accumulator 3 includes a circuit 13 configured to determine the temperature inside the casing as a function of the measured remanent magnetic field. This temperature can be determined on the basis of a law of temperature as a function of the measured remanent magnetic field, which can be stored in the memory of the circuit 13. This law can be extrapolated from a curve such as that illustrated in FIG. 10. FIG. 11 also illustrates the saturation polarization and the anisotropic field as a function of temperature for a hexagonal barium ferrite. Such a diagram can also be used to determine the temperature inside the casing as a function of the measured remanent magnetic field.

Advantageously the accumulator 3 includes a second magnetic sensor 12 also placed outside the casing. This magnetic sensor 12 has a sensitivity to the magnetic field inside the casing below that of the sensor 11. This sensitivity to the magnetic field inside the casing of the sensor 12 is advantageously substantially zero. The sensor 12 thus measures the ambient field, to take account for example of Earth's magnetic field. Such a lower sensitivity can be obtained by moving the sensor 12 away from the accumulator 3 or by separating it from the accumulator 3 by way of a shield. The circuit 13 advantageously measures the difference between the magnetic field measured by the sensor 11 and the magnetic field measured by the sensor 12. In the presence of certain closer unwanted sources with a given frequency congestion, the circuit 13 can apply a transfer function between the sensors 11 and 12, for example using a noise reduction technique with references, such as Wiener filtering. Thus, for a relatively low magnetic field inside the casing, it is possible to obtain a measurement of the variation in this remanent field generated by a possible heating in a relatively accurate way, by rejecting the influence of the surrounding magnetic field of the accumulator 3. In this example the accumulator 3 comprises a single sensor 11 fastened to its casing. This sensor 11 is advantageously arranged at half-length along the axis of the accumulator 3, in order to be able to optimally detect the rises in temperature in the casing over the length of the accumulator 3. Several magnetic sensors 11 will of course be radially distributed around the accumulator 3, or along the axis of the accumulator 3.

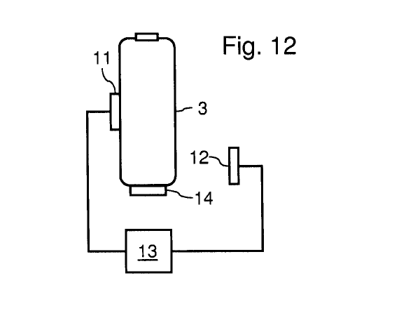

In order to reinforce the variation in the amplitude of the remanent magnetic field generated by a heating of the ferromagnetic material in the casing due to a possible short-circuit, in order to control the orientation of said field with regard to the orientation of the sensor 11, or in order to enable the recalibration of the remanent magnetic field, in the second variant illustrated in FIG. 12, the accumulator 3 advantageously comprises a device 14 for magnetizing the inside of the casing. The magnetizing device 14 is for example configured to generate a magnetic field oriented perpendicularly to the axis of the accumulator 3, prior to a measurement by the sensor 11. Advantageously, the magnetization device 14 is configured to generate a magnetic field inside the casing of the accumulator 3 on command, dynamically. Thus, the magnetizing device 14 can include a winding configured to apply to this magnetic field inside the casing only when this winding is electrically powered.

Advantageously, the circuit 13 is configured to alternate the supply of power to such a winding (and thus the generation of the magnetic field magnetizing the ferromagnetic material) and the recovery of a magnetic field measurement performed by the sensor 11 (and where applicable the sensor 12). Thus, the magnetic field measurement taken into account by the sensor 11 (and where applicable the sensor 12) does indeed correspond to the remanent magnetic field of the ferromagnetic material inside the casing, used to determine the temperature inside the accumulator 3.

FIG. 6 illustrates the difference between the magnetic fields measured by the magnetic sensors 11 and 12. FIG. 7 illustrates the temperature measured simultaneously during the loop illustrated in FIG. 4 by a thermocouple outside the casing. The sensors 11 and 12 used are, for example, fluxgates marketed under the reference number FLC100 by Stefan Mayer Instruments.

During heating, the difference between the measured magnetic fields (corresponding to the remanent magnetic field) increases rapidly then decreases gradually with the heating inside the casing of the accumulator 3. When the cooling phase is initiated, the difference between the measured magnetic fields decreases rapidly, then increases gradually with the cooling inside the casing of the accumulator 3. At the end of the cooling, when the inside of the casing of the accumulator 3 returns to its initial temperature, the difference between the magnetic fields more or less returns to its original value, with a separation of only 25 nT. Thus, it can be considered that the measurement of magnetic fields makes it possible to perform repetitive measurements of temperature in a very reliable way.

While it is necessary to immerse a thermocouple into the accumulator 3 to carry out a meaningful thermal measurement and enable identification of a possible malfunction, a temperature measurement according to the invention makes it possible to identify a malfunction without altering the integrity of the accumulator 3 and in a short time.

FIG. 8 illustrates an electrical power supply system 1. In this power supply system, a battery 2 comprises several electrochemical accumulators 3 according to the invention. An electrical load 5 is connected across the terminals of the battery 2 by way of a driven switch 15.

Each accumulator 3 comprises a magnetic sensor 11 measuring the remanent magnetic field inside its casing. The sensors 11 are connected to a common drive circuit 13. The common drive circuit 13 advantageously drives the respective magnetizing devices of the accumulators 3. A common magnetic sensor 12 measures the magnetic field surrounding the battery 2. By measuring the difference between each of the remanent magnetic fields measured by the sensors 11 and by the sensor 12, the drive circuit 13 deduces the temperature inside the casing of each of the accumulators 3.

In the second variant, the common drive circuit 13 advantageously drives the prior application of a magnetizing magnetic field by way of the magnetizing device 14. The drive circuit 13 then drives the magnetizing device 14 to suppress the magnetic field applied by the latter. The remanent magnetic field is then measured by measuring the difference between the sensors 11 and 12, in the absence of the magnetizing magnetic field.

When the temperature determined for one of the accumulators 3 exceeds a threshold, the drive circuit 13 can drive the opening of the switch 15 in order to interrupt the discharging of the battery 2 into the electrical load 5. The drive circuit 13 can thus limit the consequences of a short-circuit inside one of the accumulators 3. The drive circuit 13 thus ensures the supervision of the operation of the accumulators 3.

In this example the electrical load 5 is decoupled from the battery assembly 2 by way of the switch 15. It is also possible to envision insulating only an accumulator 3 whose malfunction has been identified, by disconnecting it from the other accumulators of the battery 2, in order to avoid a discharge of the other accumulators toward the latter, and guaranteeing the continuity of service of the battery 2. Switches can thus be included in the battery 2 in order to be able to insulate each of the accumulators 3 by a command from the circuit 13.

For lithium batteries, the normal operating temperature can reach 60° C., or even 80° C. Beyond the normal operating temperature, the performance of the battery deteriorates heavily and the latter can become dangerous. Up to a safety temperature of 110° C., or even 130° C., the phenomenon is however reversible. Beyond this safety temperature, one is faced with a thermal runaway phenomenon. The circuit 13 can thus be programmed to generate a first alarm signal and insulate a battery 2 when its temperature is above the normal operating temperature and to generate a second alarm signal when the temperature of this battery 2 is above the safety temperature, with a view, for example, of activating an extinguisher or quenching in an inert gas.

Although the accumulator 3 is a roll accumulator in the illustrated example, the invention of course also applies to other accumulator structures, for example an accumulator including a stack of electrode and separator films. Such an accumulator can in particular have a non-cylindrical shape. The accumulator can for example be of prismatic type and include a stack of flat layers of electrodes and separators.

The securing of an accumulator 3 has been described in the context of a discharge of the latter into an electrical load. The securing of an accumulator 3 can of course also be carried out when the latter is connected to a recharging system.

1. An electrochemical accumulator, comprising:
a casing;
at least two electrodes and an electrolyte contained in the casing;
a ferromagnetic material contained in the casing and having remanent magnetization;
a magnetic sensor arranged outside the casing and capable of measuring a remanent magnetic fields of said ferromagnetic material;
a circuit configured to determine the temperature inside the casing as a function of the measured remanent magnetic field.

2. The electrochemical accumulator as claimed in claim 1, wherein said electrodes each include a respective electrode film, said electrode films being superposed in alternation, and said electrode films being separated by at least one insulating separator film.

3. The electrochemical accumulator as claimed in claim 2, wherein said films are wound around one and the same axis.

4. The electrochemical accumulator as claimed in claim 3, wherein said magnetic sensor is capable of measuring a component of the magnetic field inside the casing perpendicular to said axis.

5. The electrochemical accumulator as claimed in claim 2, wherein said at least one of said electrodes includes LiFePO4.

6. The electrochemical accumulator as claimed in claim 2, wherein at least one of said electrodes includes strontium ferrite or barium ferrite.

7. The electrochemical accumulator as claimed in claim 2, wherein at least one of said electrodes includes a material having a saturation polarization above 0.4 T at 0° C.

8. The electrochemical accumulator as claimed in claim 1, wherein said ferromagnetic material has a Curie temperature below 600° C.

9. The electrochemical accumulator as claimed in claim 1, wherein said magnetic sensor includes a first magnetic sensor, and a second magnetic sensor arranged outside the casing and having a sensitivity to the magnetic field of the inside of the casing below the sensitivity of the first magnetic sensor to this same field.

10. The electrochemical accumulator as claimed in claim 9, wherein the circuit determines the temperature inside the casing as a function of the difference between the field measured by the first sensor and the field measured by the second sensor.

11. The electrochemical accumulator as claimed in claim 1, further including a magnetizing device for magnetizing the inside of the casing, the magnetizing device including a winding configured to apply a magnetic field to the inside of the casing when the winding is electrically powered, said circuit being configured to drive an electrical power supply of said winding and configured to recover a measurement of the magnetic sensor, the circuit being configured to alternately drive the electrical power supply of the winding and recover measurements from the magnetic sensor.

12. The electrochemical accumulator as claimed in claim 1, wherein said magnetic sensor is configured to measure the remanent magnetic field inside the casing in the absence of a magnetizing magnetic field being applied inside the casing.

13. A power supply system having terminals adapted to be connected to an electrical load, comprising:
an electrochemical accumulator;
a switch selectively connecting and disconnecting the electrochemical accumulator from the terminals of the power supply system;
a circuit for supervising the operation of the electrochemical accumulator and driving the disconnection of the electrochemical accumulator and from the terminals of the power supply system when a temperature measured by said sensor crosses a threshold
wherein the electrochemical accumulator, comprises:
a casing;
at least two electrodes and an electrolyte contained in the casing;
a ferromagnetic material contained in the casing and having remanent magnetization;
a magnetic sensor arranged outside the casing and capable of measuring a remanent magnetic field of said ferromagnetic material; and
a circuit configured to determine the temperature inside the casing as a function of the measured remanent magnetic field.
